(19) United States
(12) Patent Application Publication
(10) Pub. No.: US 2014/0225528 A1
(43) Pub. Date: Aug. 14, 2014

(54) Devices, Systems, Architectures, and Methods for Lighting and other Building Control applications

(71) Applicant: Randy Clayton, Frederick, MD (US)

(72) Inventor: Randy Clayton, Frederick, MD (US)

(21) Appl. No.: 14/214,227

(22) Filed: Mar. 14, 2014

Related U.S. Application Data
(63) Continuation-in-part of application No. 13/103,458, filed on May 9, 2011, now Pat. No. 8,504,174.
(60) Provisional application No. 61/792,312, filed on Mar. 15, 2013.
(60) Provisional application No. 61/813,634, filed on Apr. 18, 2013.
(60) Provisional application No. 61/814,805, filed on Apr. 22, 2013.

(51) Int. Cl. H05B 33/08

(52) U.S. Cl. CPC H05B 33/0845
USPC 315/294

(57) ABSTRACT

The present invention provides, among other things, a reconfigurable, lighting and building control system. The system includes an area controller designed as a removable panel ceiling panel replacement positioned in or proximate an area being controlled. The area controller controls the operation of the lighting fixtures wirelessly or via the low voltage/control wiring based on at least one of day and time, occupancy, and light intensity in the area.

### CROSS-REFERENCE TO RELATED APPLICATIONS

This application claims the benefit of U.S. Provisional Patent Application Nos. 61/792,312 filed Mar. 15, 2013, 61/813,634 filed Apr. 18, 2013, and 61/814,805 filed Apr. 22, 2013 and is a continuation in part of U.S. patent application Ser. No. 13/103,458 filed May 11, 2011, all of which are incorporated herein by reference.

### STATEMENT REGARDING FEDERALLY-SPONSORED RESEARCH AND DEVELOPMENT

Not Applicable.

### FIELD OF THE INVENTION

The present invention is directed generally to building control devices, systems, methods, and architectures and, more specifically, to those, systems, methods, and architectures that support cost effective installation, maintenance, and reconfiguration of lighting and other building controls.

### BACKGROUND OF THE INVENTION

Traditionally, building control systems have been more widely implemented in large commercial and industrial buildings than in other buildings. These systems often included centralized control panels, custom (“built-up”) HVAC systems, etc. that may be further controlled via customizable building management or automation systems (“BMS”, “BAS”). There are several reasons for the lack of more wide spread adoption of these systems including high upfront costs, system complexity, functionality, the need for control specialists, maintenance costs, etc.

The rising cost of energy, government mandates, and advancements in automation technology is increasing the adoption of building control systems across all types of buildings. Initial mandated requirements for building control systems focused on the use of unmanaged, distributed controls, such as motion sensing light switches and programmable thermostats for HVAC systems. These unmanaged, distributed controls have provided more local control over conditions within building and produced energy savings, but have not provided system level visibility or the overall control provided by a centralized panel systems and BMS that is needed to actually manage building systems. For example, motion-sensor light switches are set to turn off after a fixed time, irrespective of the time of day, while programmable thermostat are set to operate at a given temperature at a given day and time, irrespective of whether anyone was present in the building. Furthermore, the building operator has no ability to review data about the operation of the building systems and the effectiveness of their building control strategies.

While additional money and energy can be saved by implementing more advanced building management systems, the installation and reconfiguration cost of controllable lighting, HVAC, and plug devices, and the associated controls can be prohibitive. For example, highly skilled and compensated electrical, HVAC, and controls contractors are often required to perform high voltage wiring for power and install control wires throughout a building and to custom install and program HVAC and building management systems. As such, building developers and operators are seeking ways to reduce the overall cost of procuring, installing, maintaining, and reconfiguring these systems.

Wireless building controls have significantly reduced the installation cost for building controls by generally eliminating the need to run control wire to most electrical devices being controlled. Wireless solutions also enable spaces to be reconfigured without having to rewire the building, which provides a further benefit. However, the flexibility created by wireless controls does not extend the high voltage wiring required to deliver power to lights and other devices throughout the building.

Others have attempted to reduce cost by delivering power and control signals to devices over the same wiring infrastructure, thereby eliminating the material and labor cost associated with the second wiring infrastructure. For example, power line communication systems (“PLC”) deliver control signals over the building electrical power wiring, which eliminates control wiring. Others have attempted to provide power over the centralized panel control wiring deployed in the building to reduce the amount of high voltage wiring in the building. Unfortunately, PLC has not provided the desire reliability, likely due, at least in part, to the building electrical power infrastructure not being well suited as a control infrastructure. Conversely, providing power over the centralized panel control wiring has also presented challenged for several reasons including limitations on the number and type of devices and the distances is limited by the amount of power that can be distributed over the control wiring. As such, these systems often result in non-standardized, custom wiring systems that also can present further challenges for maintenance and reconfiguration. And, in some instances, actually increase the amount of wiring, because of the continuing need for line voltage wiring.

As technology has advanced, control systems are becoming increasingly capable of managing a wide variety of building and building systems, such as HVAC, lighting, plug loads, etc. that consume energy, and providing near real time monitoring, control, and data collection capabilities. What is needed are control devices, methods, systems and architectures that enable these advanced technologies to be implemented cost effectively and efficiently in buildings.

### BRIEF SUMMARY OF THE INVENTION

The present invention provides, among other things, devices, systems, architectures, and methods for low voltage lighting and other building control applications that can be cost effectively implemented and operated in a wide array of buildings. The systems provide for powering low voltage lighting fixtures in an area from an area-based power distribution panel that can be further configured to provide oversight and control of the low voltage lighting fixtures and other devices in the area. The system can operate as a stand-alone control system, as an integrated part of a building management and automation system (BMS/BAS), or within a wired and/or wireless building or lighting control/management system.

The systems and architecture take advantage of the building electrical power architecture to deliver line voltage power to discrete areas in the building. At those discrete areas, area controllers are introduced to communicate with and control peripheral devices performing building control functions and to convert line voltage power to a lower voltage power that can be used to power the peripheral devices in the area, such as lighting, sensors, device controllers, etc. For example, the area controller can include an AC-DC converter that converts line voltage (e.g., 120V-347V) AC power to DC power (e.g., 48V, 24V, etc.) that can be used to power low voltage light fixtures, such as LEDs, fluorescents, etc. and controls devices, such as 0-10V & 4-20 mA dimming light and monitoring controls, occupancy, contact, daylight, and other sensors, switches, etc. Low voltage power as used herein generally refers to electrical power where the wiring and distribution infrastructure can be handled by personnel that are not electricians in a non-residential setting, e.g., Isolated Low Voltage Limited Energy (LVLE) circuit such as NEC class 2. Whereas, high or line voltage power require an electrician to perform such tasks in a non-residential setting, such as NEC Class 1.

In various embodiments, the area controller is fed off a branch to the line voltage power source, where the line voltage is fed to various other points in the area, such as to power electrical plug outlets and provide critical power. The area controller converts the line voltage to a lower voltage that is used to power various control devices, light fixtures, etc. The use of lower voltage power for various devices and fixtures lowers the wiring and installation cost for the system, and is generally considered safer.

In various embodiments, the system includes wireless control devices that communicate with the area controller via wireless communication signals, such as Zigbee, other 802.x formats, proprietary protocols such as EnOcean, Zwave, etc. The system can include control devices and fixtures, e.g. lights, that can operate on line voltage power or lower voltage power provided by the area controller and control communications can be provided via control or power wiring or wirelessly.

The present invention provides an opportunity for a building owner/operator to pre-wire at least the line/high voltage wiring in a portion or all of a building in a generic configuration, e.g., grid, to support multiple arrangements for ceiling lighting and perhaps other electrified areas including walls and floors to support plug loads, wall lighting, HVAC, etc. For example, during a build-out, the electrical contractor can install electrical outlets in a desired spacing in the area above where a removable panel ceiling is or will be installed. The area controller can be configured as a panel in a removable panel ceiling (also, referred to as a “reflected ceiling” or “drop ceiling”). The area controllers can be positioned in a desired location in the removable panel ceiling grid, which is typically proximate to an area and lighting that is to be controlled by the area controller, such that wiring can be performed over relatively short, i.e., manageable, distances. The area controllers are plugged into one or more of the electrical outlets above the ceiling. Wiring suitable for low voltage power and communication is connected between the area controller and the lights and other devices to be controlled and/or powered, as well as the wired switches, sensors, etc. powered by and communicating with the controller.

Among other things, the present invention enables a low voltage reconfigurable lighting system. The system includes an area controller configured to receive power from an electrical plug outlet and provide power and control signals to one or more lights. As such, the system can be reconfigured at will by a building operator, because the area controller and lights are low voltage and are only tied to the line/high voltage electrical infrastructure via an electrical plug. In practice, a building operator can reconfigure a space by unplugging the area controller from electrical plug outlet, disconnecting the low voltage power lines from the area controller and/or the light(s) to be moved, relocating the area controller and/or the light(s), reconnecting the low voltage power lines between the light(s) and the area controller, and plugging the area controller back into the plug outlet. The plug on the area controller can generally be a standard plug, preferably 3-prong, and can include a fastener to reduce the likelihood that the plug will be inadvertently pulled out.

The system can be implemented in various ways. For example, line voltage can be supplied to the area controller, where is converted to lower voltage direct current power that is used to power dimming light controllers and LED fixtures in the area. The area controller can be connected to the electrical infrastructure through a plug outlet or a junction box.

The area controller can communicate wirelessly with switches, plug load controllers, sensors, and other devices as desired. Communication with the control devices and fixtures can be wireless or via the low voltage power lines. Traditional wired switches and dimmer can be reused to communicate with the area controller or other control devices installed in the area and used to control the same lights as in prior configurations or other devices via the area controller. As used herein, low voltage power lines, wires, or wiring includes any wiring that is suitable for use with low voltage power including wiring that may also be suitable for high voltage applications as discussed above.

The area controller can also provide an interface to other systems depending upon the building in which it is deployed. For example, in hospitality applications, the area controller and/or the building automation controller may interface with a guest reservation/check-in system. In hospital applications, a nurse call system may be interfaced with the system. Security systems can be interfaced with the system in a variety of building types.

In hospitality, patient care (e.g., hospitals), and other applications, the area controllers may be deployed in each room and in zones in the common areas. Other applications may not require a room level granularity for area control, so the area controllers may be deployed in a variety of zones tailored to a specific application or area configuration.

By eliminating the need for control wire to be wired back to a centralized control location, i.e., wiring home-runs, while at the same time eliminating the power restrictions on devices and non-standard wiring layouts, the present invention provides reliable devices, methods, systems and architectures for power delivery and device control that addresses many limitations of the prior art as will become further apparent from the specification and drawings.

### BRIEF DESCRIPTION OF THE SEVERAL VIEWS OF THE DRAWING

The accompanying drawings are included for the purpose of exemplary illustration of various aspects of the present invention, and not for purposes of limiting the invention, wherein:

FIGS. 1-3 show embodiments of automation systems;

FIGS. 4-5C shows exemplary area/room control architectures

FIGS. 6A-6C show a building and an area controller (AC) as a replacement panel in a removable panel ceiling grid; and,

FIGS. 7A-7C show exemplary area controller housings.

It will be appreciated that the implementations, features, etc. described with respect to embodiments in specific figures may be implemented with respect to other embodiments in other figures, unless expressly stated, or otherwise not possible.

### DETAILED DESCRIPTION OF THE INVENTION

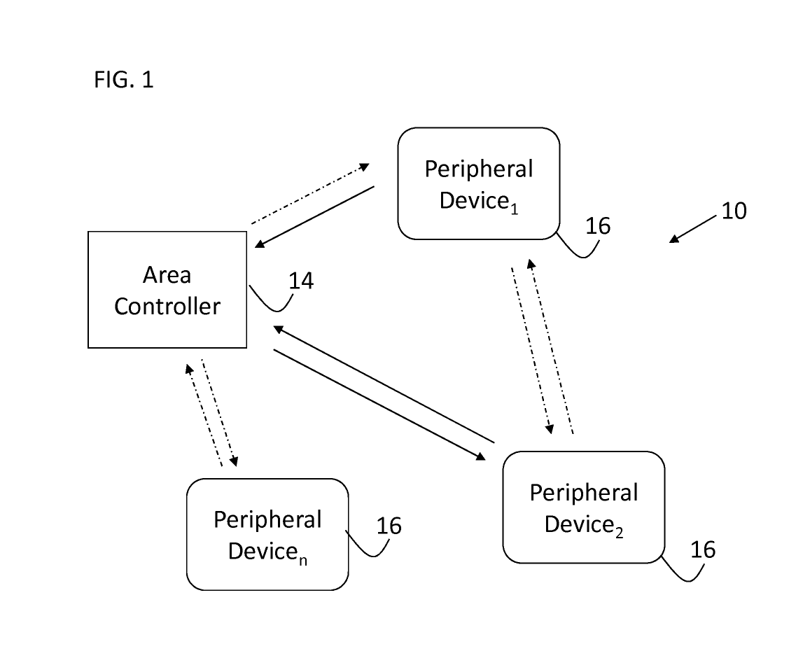

FIG. 1 depicts an automation system 10 embodiment of the present invention that includes an area controller 14 providing communication to and control over one or more peripheral devices 16₁₋ₙ in an area of a building. The area controller 14 further provides low voltage power to one or more of the peripheral devices 16 in the area, such as low voltage lighting and various control devices including dimming light controllers, sensors, switches, thermostats, protocol translators, etc. The area controller 14, generally speaking is a specific purpose computer including processing, storage, and i/o capabilities suitable sized for the desired performance with wireless and/or wired transceivers for communication with the peripheral devices 16 and one or more automation controllers 12. The area controllers 14 further include one or more power conversion units that convert the line voltage from the building electrical system to a lower voltage that can be used to power various devices in the area, such as lighting, sensors, etc. For example, the area controller 14 can include an AC-DC converter that converts line voltage (e.g., 120V-347V, NEC Class 1) AC power to DC power (e.g., 48V, 24V, NEC Class 2) that can be used to power low voltage light fixtures, such as LEDs, fluorescents, etc., controls devices, such as light dimming and monitoring controls (e.g., 0-10V & 4-20 mA), occupancy, contact, daylight, and other sensors, etc., and other low power devices that may be in the area.

The use of lower voltage power for various devices and fixtures lowers the overall cost of the system and is generally considered safer than line voltage power wiring, devices, and fixtures. For example, class 2 wiring can be used for the lower voltage applications, which can be installed and reconfigured by personnel qualified for lower voltage applications. Another benefit of the architecture is that existing high voltage wiring in the building can be reused and reconfigured to carry lower voltage power when buildings are being retrofit.

In various embodiments, the area controller 14 is fed off a branch to the line voltage power source, where the line voltage may fed to various other points in the area, such as to power electrical plug outlets. In applications, such as patient care facilities, it may be desirable to have one branch of line voltage power dedicated to critical power systems and another branch dedicated to normal power systems. Critical power systems may have additional back-up power supplies and power conditioning equipment that may be needed or desirable when supplying power to critical equipment, such as for medical applications, information technology, security, etc.

In various embodiments, the system 10 includes wireless peripheral control devices 16 that communicate with the area controller 14 via wireless protocols, such as Zigbee, other 802.xx based formats, proprietary protocols (e.g., EnOcean, Zwave), etc. The system 10 can also include control devices and fixtures, e.g. lights, that can operate on line voltage power or lower voltage power provided by the area controller 14, which are configured to communicate with the area controller 14 and/or automation controller 12 via control or power wiring or wirelessly.

The system 10 can be implemented in various ways. For example, line voltage can be supplied to the area controller 14, where is converted to lower voltage direct current power that is used to power LED fixtures in the area. The area controller 14 communicates wirelessly with switches, plug load controllers, sensors, and other devices as desired. Communication with the devices, e.g., LED lights and controllers, to provide control signals and information, status, etc. can also be wireless or via the low voltage power lines. Traditional wired switches can be reconfigured to communicate with the area controller 14 or other control devices installed in the area and used to control the same lights as in prior configurations or other devices via the area controller 14.

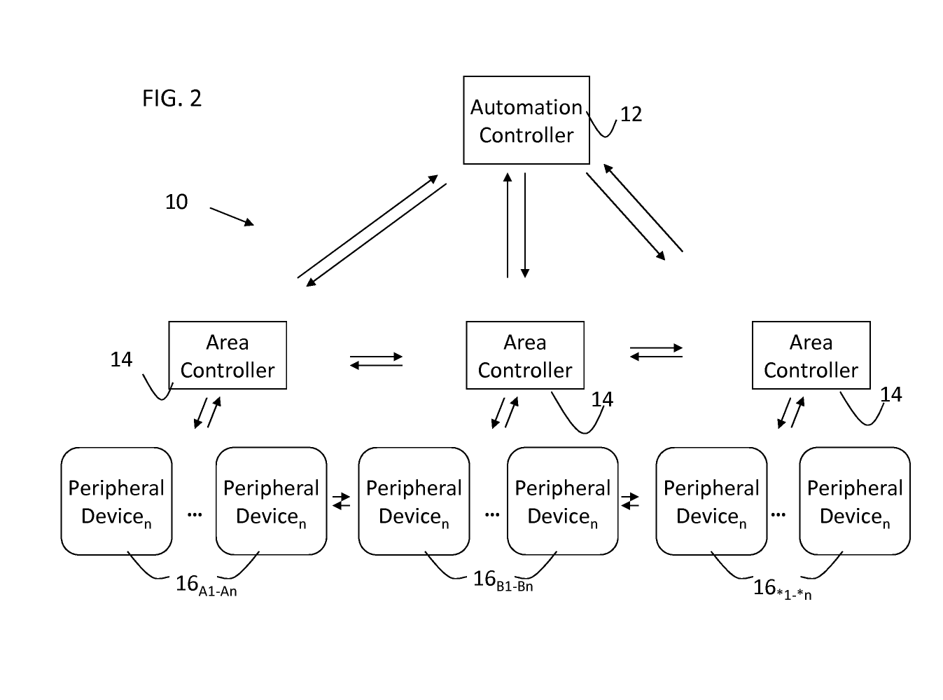

FIG. 2 depicts embodiments of the system 10 that include at least one automation controller 12 that communicates with a plurality of area controllers 14 in communication with various peripheral devices 16. In these embodiments, the automation controller 12, generally speaking is a specific purpose computer including processing, storage, and i/o capabilities suitable sized for the desired performance with wireless and/or wired transceivers for communication with the peripheral devices 16, area controllers 14, and often one or more external networks.

Communication between the automation controller 12, area controller 14, and the peripheral devices 16 can be wired and/or wireless depending upon the particular implementation. Wired communication can make use of the power and control lines, local area networks, or direct links between communication ports, such as USB, RS-232 and 485, etc. Wireless communications can employ one or more wireless technologies based on various protocols, such as Zigbee, Z-wave, Bluetooth, Wi-Fi, and/or other proprietary and/or open standard, e.g., IEEE 802.x, EnOcean, for transmitting signals in the infrared and/or radio frequency spectrum. Zigbee may be preferentially employed as a basis for a wireless communication protocol used in the system 10 as it is based on open standard IEEE 802.15.4 for low power, reliable, non-line of sight communication for automation systems. However, the skilled artisan can select a protocol suitable to desired systems and applications.

The automation controller 12 interacts with an area controller 14 coordinating the peripheral devices 16 within an area. For example, the area controller 14 can include or be associated with various sensors, such as temperature, light intensity, and motion, in the area, which provide local information used to control the area environment, as well as for use by the automation controller 12. In some instances, the area controller 14 could be used merely to provide a single point of contact for a given area to the automation controller 12 or could be configured to control various actions of the peripheral devices 16 in the area. In various embodiments, the area controller 14 can be used to turn power on and off to an area, which can be triggered manually, flipping a switch, inserting a card, etc. or upon detection of a person, via RFID or otherwise, in addition to being automatically controlled by the automation controller 12.

It will be appreciated that while the peripheral devices 16 and area controllers 14 within each room can operate separately from the peripheral devices 16 and area controllers 14 in other rooms, while simultaneously operating as part of a larger overall network, such that devices 16 and area controllers 14 can serve as repeaters for signals being sent from other areas or devices, such as wireless sensors, etc., within the room. It will be further appreciated that it may be desirable to architect the overall network into sub-networks to reduce the amount of traffic being repeated in a larger network, while still maintaining a device 16 and controller 14 density to enable reliable wireless sub-networks.

For example, it may be desirable to disable the repeater functionality on various peripheral devices 16 in the network, which will enable those devices to perform the assigned function in the system. The disabling of repeater functionality can be performed on a number of bases as decided by the skilled artisan. For example, if a particular device or device class is particularly consumed performing its system function, e.g., controlling a thermostat, dimming lights, processing sensor data, then repeater functionality can be disabled on those devices.

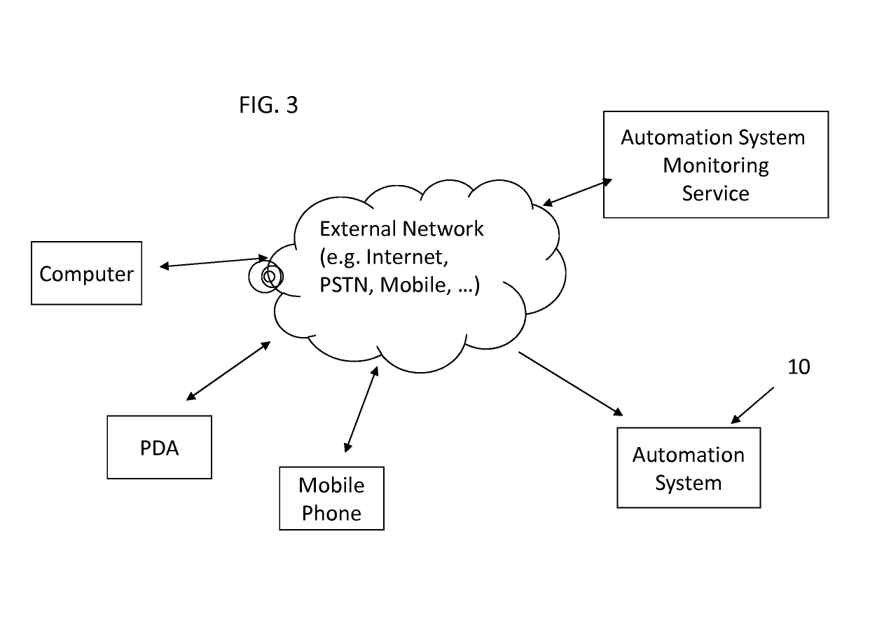

As shown in FIG. 3, the system 10 can be connected to external networks to enable remote monitoring and control of the system 10. The area controller 14 can be configured to be accessible directly via computer or another input/output device, locally via wired or wireless local area networks, and/or remotely via a wide area area network, such as a wired or wireless telephone network and Internet.

The automation controller 12 can be in the form of one or more premise-based management devices that oversee and control the operation of the system 10 and may be locally and/or remotely accessed. Alternatively, it may be desirable in some instances for the automation controller 12 to be off-site (e.g., “in the cloud” or merely remote) and communicate with and control the system 10 via one or more gateways that are provided on the premise or via a virtual private network (“VPN”). In various embodiments, the gateway may be built into the area controller 14, such that each area controller 14 communicates with the automation controller 12 via an external network.

The automation controller 12 can be configured to communicate directly with peripheral devices 16 that, during normal operation, communicate with and are controlled by one of the area controller 14. In this manner, the automation controller 12 can step in for an area controller 14 that becomes unavailable to communicate with or control the peripheral devices 16. Other override functionality can be also be implemented by direct control from the automation controller 12, such as implementing a demand-response override that changes the light level (intensity), the heating/cooling set points, etc. during peak energy cost or consumption periods, emergencies, etc.

The automation controller 12 can also receive various inputs from premise wide systems, such as access control systems or manually from a front desk or other check-in stations, a mobile device, or other notification means that can be used to change the room from an unoccupied to an occupied state. While the latency of the system 10 is likely better with a premise-based automation controller 12, the external systems can be interfaced with an off-site automation controller 12.

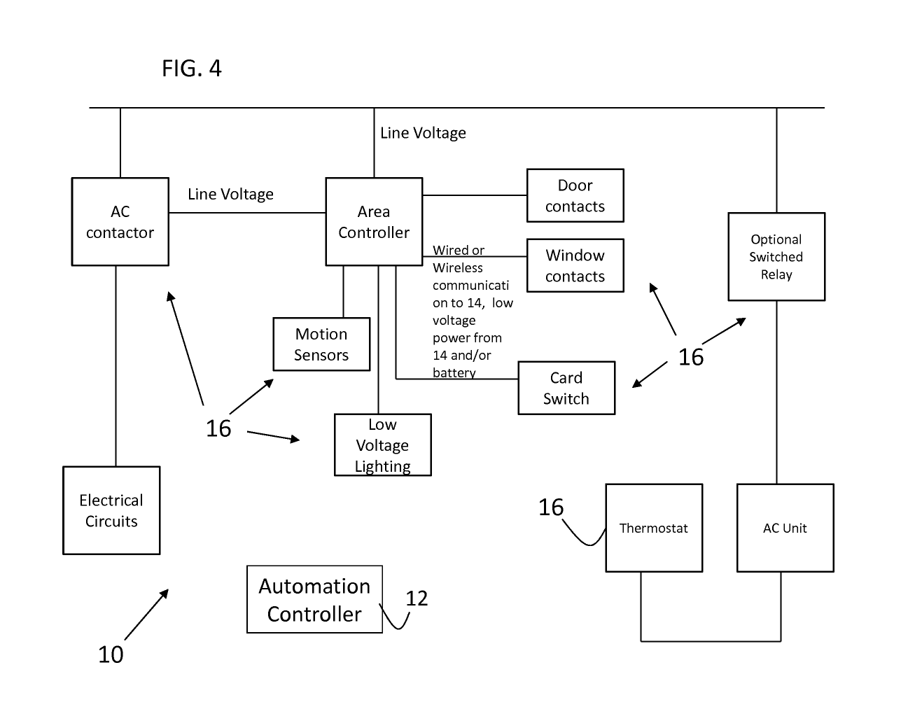

FIG. 4 show embodiments of the system 10 including an area controller 14 configured to provide lower voltage power to and control a variety of peripheral devices including AC contactors and relays that control circuits in an area, various sensors (motion, contact, daylight) and wired and wireless switches, and lower voltage lighting. In room applications, such in the hospitality, patient care, and other multi-tenant facilities, the area controller 14 can receive input from card switch, as well as the various sensors, which can be used to control a thermostat, lighting, and plug loads based on occupancy, as well as schedules.

During operation, it may be desirable for the system 10 to begin transitioning an area or facility to a different state ahead of the actual occupancy event via at least one intermediate state, such as pre-occupied for arriving and pre-unoccupied for leaving. These intermediate states can be configured to place the area in a more energy efficient state until the occupancy event occurs. If the occupancy event does not occur, then the area would revert to its prior state. For example, a room may be transitioned to a pre-occupied state based on a schedule arrival time for a guest, a scheduled meeting in a room, input from a premise access control system, or notice from a mobile device. Conversely, the area may be transitioned to a pre-unoccupied state, when it is scheduled to be unoccupied or upon command, but revert to the occupied state, if the area remains occupied for a predetermined period of time.

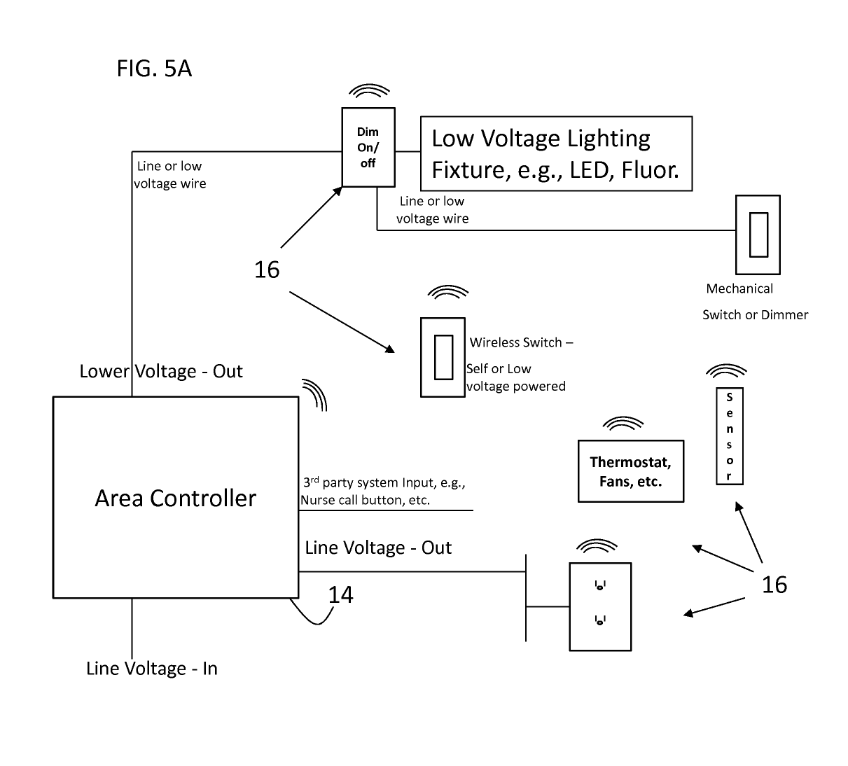

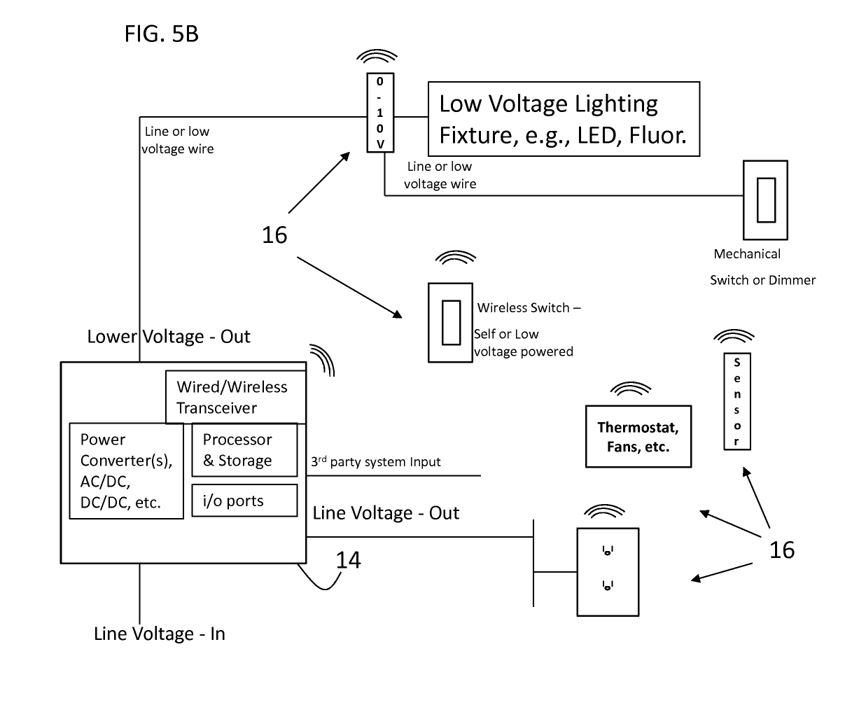

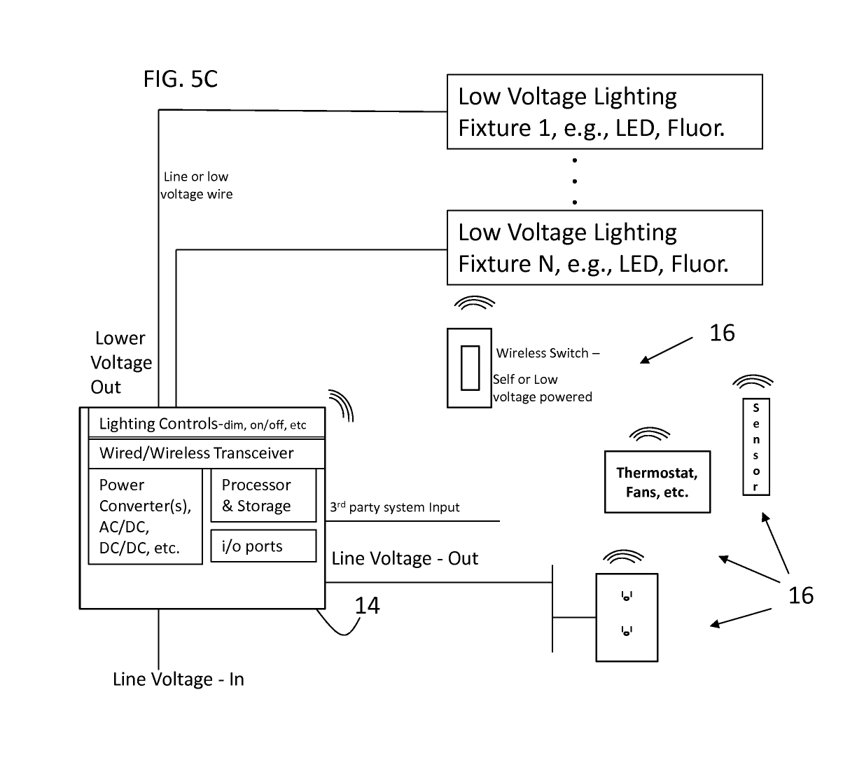

FIGS. 5A-5C show more specific embodiments of the system 10 at the area controller 14 level that can be implemented in various architectures with or without automation controllers 12 or other high level controllers. The area controller 14 receives line voltage power (e.g., 120V AC) from the building electrical infrastructure via an electrical outlet plug or junction box and converts at least a portion of the line voltage power to a lower voltage (e.g., 48V DC) and provide the lower voltage power to a low voltage fixture, such as a LED or fluorescent fixture, and/or an associated light dimming control device, such as a 0-10 V controller. The area controller 14 can send a control signal to the light dimming controller to vary the power delivered by a driver to the light fixture. It will be appreciated that the area controller 14 can be configured to control the light intensity output by one or more the lighting fixtures separately from the light intensity output by other lighting fixture controlled by the area controller. The skilled artisan can also vary the power delivered to the fixture by varying the voltage and/or current supplied depending upon the control circuitry used in lighting fixture.

The skilled artisan will appreciate that while the fixture and light dimming peripheral device 16 are shown separately in FIGS. 5A-5B, the light dimming peripheral device 16 can be integrated with the fixture and/or with the area controller 14. Also, communication with the dimming peripheral device 16 can be provided using the same or different path, wire or wireless, as is being used to supply power to the fixture. It will be appreciated that light dimming control can be integrated with the area controller 14, as in FIG. 5C, enabling the area controller 14 to vary the power (voltage and/or current) supplied to the lighting fixture to control the light intensity output by the fixture using the same path, i.e., wire, or a separate or different path as is being used to supply power to the fixture. Also, it may also be desirable for the area controller 14 or light fixture to include a driver that will turn off (open the circuit), if the power delivered to the fixture is too low or a control signal is below a low-end cut off value and to limit power deliver the fixture, if the power too high or control signal above a high-end value.

Similarly, other peripheral devices 16 depicted in FIG. 5A-5C as one box may be integrated or have controllers that are separate from the actual device. For example, the wireless thermostat/fan may be configured as an RS-485 or other wired protocol communicating thermostat that interfaces with a peripheral device configured to communicate with the thermostat via RS-485 and the automation controller 12 via Zigbee or other wireless protocol. The peripheral device 16 controlling the thermostat and the thermostat can be physically housed together or separately.

Wireless and wired switches can be mapped in the area controller 14 to control various peripheral devices 16 including light controllers and plug loads that may or may not be electrically connected with the switches. The wireless switches can be self-powered or powered using batteries or lower voltage power from the area controller 14. In retrofit or reconfiguration installations, wired switches that were previously line voltage switches can be used as low voltage switches used to control different electrical devices. Plug load and circuit controllers may be configured to operate using line voltage power and wirelessly communicate with the area controllers 14 and/or automation controllers 12.

The present invention provides flexibility in the installation and reconfiguration of low voltage lighting. Generally, a suitable location for one or more automation controllers to communicate with, oversee and control area controllers and energy usage in at least one area is identified. The skilled artisan can identify any number of suitable locations, which may depend upon whether the automation controllers are communicating wirelessly and/or wired with the area controllers. It is desirable to install the area controllers 14 proximate areas that will include at least one low voltage peripheral device 16, such as an LED lighting fixture, to be powered by the area controller 14, so as to avoid excessively long wiring runs between the area controllers 14 and the low voltage devices in the area. Preferably, a line voltage power source is also proximate the location selected for the area controller 14. Wiring supporting low voltage power transmission is strung between the area controller 15 and the low voltage fixtures. The wiring can be suitable for low voltage transmission only, e.g., CAT-5, Class 2, etc. or can be suitable for both lower and higher voltage power transmission.

Consistent with the installation, the lighting control system of the present invention can operate by converting a line voltage power source input (120V to 347V AC) to the area controller into lower voltage power (12VDC-48VDC). The lower voltage power is provided to one or more low voltage lighting fixtures in the area. The area controller 14 provides control signals to vary the light intensity output by the low voltage lighting fixtures.

In operation, building controls software can be operating on the automation controller 12 and/or directly on the area controller 14 that allows a local and/or remote user to configure that the operation of the system 10. The software implements schedules and device relationships and operating rules and stores operational data locally and/or remotely as desired by the operator. For example, a user can configure dimmable light fixtures to provide a maximum light intensity as measured by a photosensor or based on the controller voltage. Likewise, a low-end cut-off can be provided at a minimum intensity level, where the light fixture is turned off to reduce further energy consumption.

The area controller 14 can be deployed proximate the devices that are to be controlled, such that any desired wiring can be performed over a short distance. For example, in various embodiments, the area controller 14 controls a room and is seated as a panel in a removable panel ceiling (also, referred to as a “reflected ceiling” or “drop ceiling”), similar to lighting and HVAC vents. In other embodiments, the area controller 14 is deployed above the removable panel ceiling within or recessed in the walls or floor, as a panel in a raised floor, or merely attached to a surface in the area.

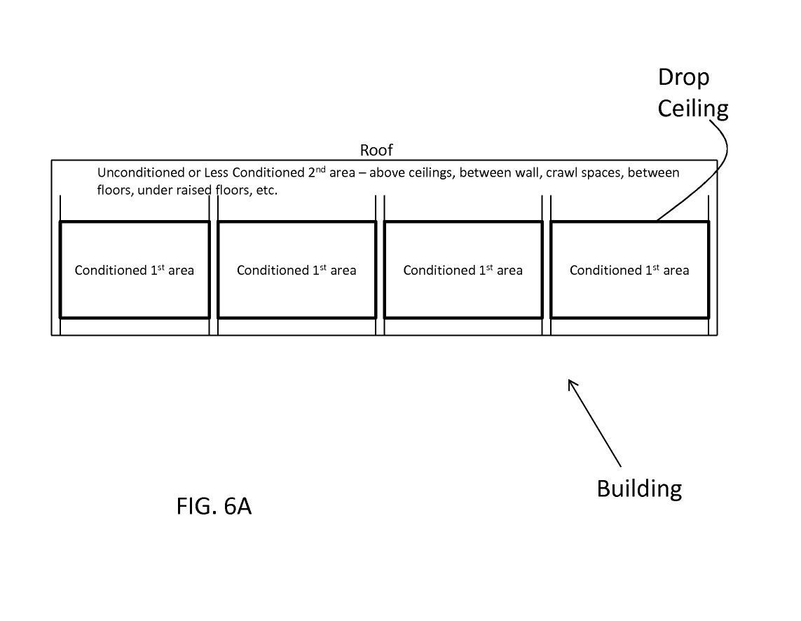

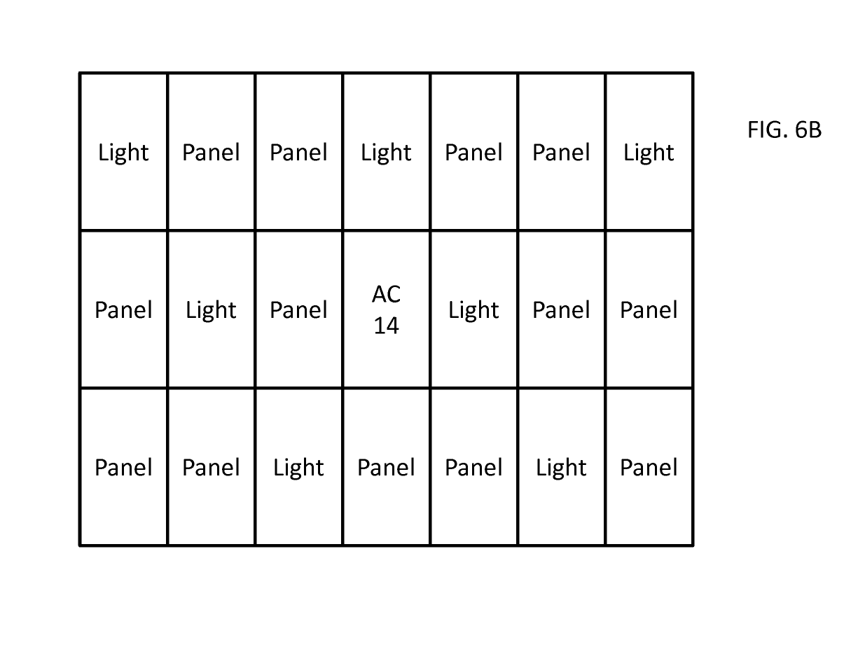

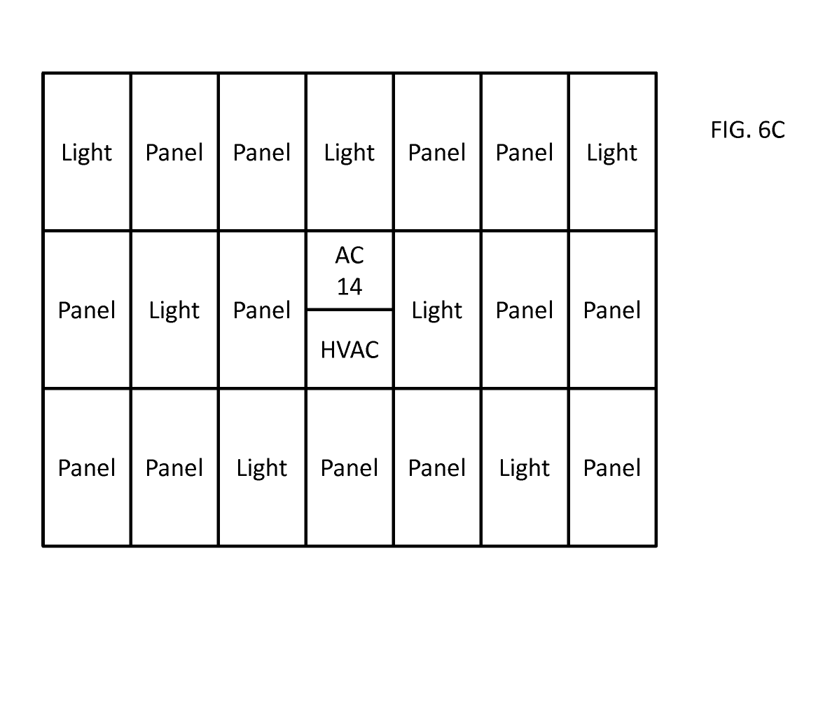

In many buildings, the area above a removable panel ceiling, within walls, and below floors is often unconditioned or conditioned to a lesser extent from a perspective of HVAC, air quality, etc., as depicted in FIG. 6A-6C. As such, as used herein, a building space may be referenced as a conditioned first area, which is the area of the building that is intended to be occupied and used more generally, which heated, cooled, lit, air filtered, etc. There is also a lesser conditioned or unconditioned second area of the building, which is not occupied or frequently used by occupants, such as the area within the walls, below flooring, above removable panel ceilings, crawl spaces, and perhaps basements and attics depending upon how a building is configured.

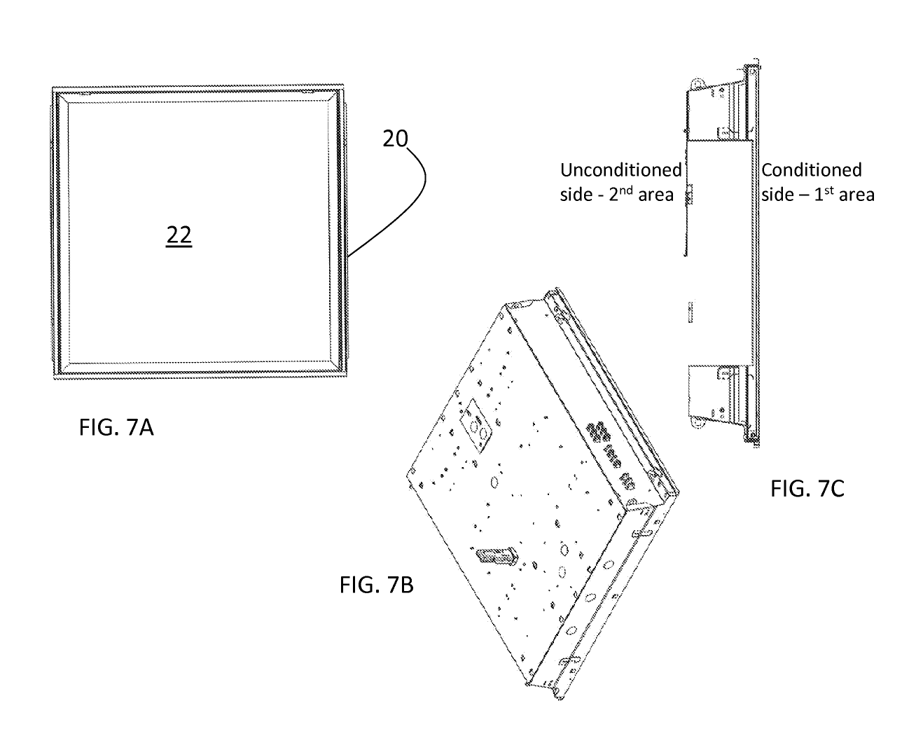

In various embodiments, the area controller 14 includes a housing 20 configured as a removable panel ceiling panel replacement, in which some or all of the electronics are housed on the side of the housing facing the conditioned space. The housing can be similar in design to a lighting troffer, such as in FIGS. 7A-7C and constructed of similar materials, typically sheet metal. The controller components can be mounted on the side of the housing facing the conditioned space, so the components are exposed to a more conditioned environment than devices placed above the removable panel ceiling or within walls and floors, as shown in FIGS. 6A-6C. It will be appreciated that the side of the housing facing the conditioned area may have a cover 22 for aesthetic and equipment protection purposes.

The cover 22 preferably supports air flow through the inside of the housing facing the conditioned area of the room. The amount of ventilation provided by the cover 22 from the conditioned side of the room can be determined as desired by the skilled artisan. The housing may include some level of venting through to the side of housing to the unconditioned area and include various types of punch-out to enable wired connections to be made on the side of the housing facing the unconditioned space and to vent heat generated by components on the conditioned side of the housing.

In some instances, it may be desirable to be desirable to employ multiple types of wireless and wired transceivers in the area controller 14. In addition, it may be desirable to mount components in different locations of the housing. For example, it may be desirable to mount a wireless transceiver or at least the antenna portion of a wireless transceiver on the unconditioned side of the housing where the absence of walls supports longer wireless transmission distances when communicating with an automation controller 12 located elsewhere in the building. Similarly, long wire runs to the automation controller 12, centralized panels, and other components may be more easily performed in the unconditioned area. Shorter wire runs to wired devices in the conditioned area will often be performed in the unconditioned space or surface mounted ducts or track for aesthetic reasons. Conversely, wireless devices that communicate with devices within the conditioned space, i.e., room, such as lights, switches, sensors, equipment, etc. may be more desirably located in the housing on the conditioned side of the housing to improve the signal strength within the room (i.e., conditioned area).

In addition, it may be desirable to communicate with various devices in the system using different protocols, as well as transmission methods, e.g. wired or wireless. For example, RS-485 may be used for longer wired communications and RS-232 used for shorter communications. Similarly, the area controller 14 may employ various wireless protocols for communicating with other wirelessly communicating devices. For example, the area controller 14 may employ one or more first wireless protocols, such as Zigbee or other 802.15.4-based protocols or 802.11.x protocols for communicating northbound to automation controllers 12 and parallel (east-west) with other area controllers 14 or mobile/cellular protocols for communicating over the wireless telecommunication networks to remote servers/controllers 12. The system 10 may also include one or more second wireless protocols, which may be open or proprietary protocols, e.g., WiFi, EnOcean, etc., for communicating southbound with the devices 16 within the room or area.

Among other things, the present invention enables a low voltage reconfigurable lighting system. The system 10 includes an area controller 14 configured to receive power from a line voltage power source, e.g., an electrical plug outlet or junction box, and provide power to one or more lights and other devices 16. In cases where line voltage power is accessed via an electrical plug outlet, the system 10 can be reconfigured at will by a building operator, because the area controller 14 and lights are low voltage and are only tied to the line/high voltage electrical infrastructure via an electrical plug. In practice, a building operator can reconfigure a space by unplugging the area controller 14 from electrical plug outlet, disconnecting the low voltage power lines from the area controller 14 and/or the light(s) to be moved, relocating the area controller 14 and/or the light(s), reconnecting the low voltage power lines between the light(s) and the area controller 14, and plugging the area controller 14 back into the plug outlet. When the area controllers 14 are connected to the line voltage power source via junction boxes, the lighting can still be reconfigured as desired and additional low voltage wiring can be strung as needed. High voltage electricians can be employed to relocate area controllers 14 as needed.

The plugs on the area controller 14 can generally be a standard plug, preferably 3-prong, and constructed of materials designed to operate in lesser or unconditioned space. A fastener can be used to secure plug to the electrical outlet housing to reduce the likelihood that the plug will be inadvertently pulled out.

When deployed as part of a larger system, it may be desirable for the area controller 14 to communicate wirelessly northbound with a higher level controller 12 and east/west with other area controllers 14, which eliminates the need to run or relocate home run wiring back to the higher level controller, such as an automation controller 12, centralized panel, gateway, etc. However, in retrofit scenarios where home run wiring already exists in the building or where wiring is required for safety, security, preference, or otherwise, the area controllers 14 can be configured to communicate northbound or east/west over wired connections as desired.

Also, the system 10 provides the building operator with increased flexibility when it is enabled deployed with wireless light switches, sensors, and other wireless devices in the area. In this manner, the wireless devices in the room can be relocated when a space is reconfigured. Again, existing and new wired switches, sensors, and other devices that have been previously or are currently installed can be used as low voltage devices communicating with the area controller 14, instead of directly controlling the power being provided to the line voltage devices. When a space is reconfigured that includes wired devices, additional wiring may be required to connect the wired devices to the area controller 14 at its new location.

The system 10 of the present invention may be deployed in a stand-alone lighting control configuration that includes one area controller 14 and one or more light(s) being powered and possibly controlled by the area controller 14 and may include switches, sensors, and other devices providing other input/output or system functionality. The system can be configured to provide distributed control only, where the switch and sensor inputs to the area controller 14 are used to control the operation of lights and the area controller 14 plays the role of a centralized control point. The area controller 14 can also be configured to provide some level of management of the system based on various parameters, such as controlling the response of the lights based on schedules, occupancy, light intensity, etc., and data retention concerning the operation of the lights. Management of the area controller 14 in a stand-alone configuration can be performed by physically connecting to or operating the controller 14 or by providing wired or wireless communication to the controller 14.

Management software/firmware can run on a processor in the area controller 14 as well as in the higher level controllers in the system 10. In a stand-alone configuration, it may be desirable to enable a wireless connection to the area controller 14, such that a management session can be opened on the area controller 14 from a computer (e.g., desktops, laptops, net books, tablets, smart phones, etc.) over dedicated (e.g., Zigbee, RS-X) or non-dedicated LAN and WAN networks (WiFi, mobile). The various stand-along area controllers 14 in the building can be individually addressed and accessible by a building operator using a web browser or other means enabling local or remote control of the device controlled by the area controller 14.

The present invention provides an opportunity for building owner/operator to pre-wire the line/high voltage wiring in a portion or all of a building in a generic configuration, e.g., grid, to support multiple arrangements for ceiling lighting and perhaps other electrified areas including walls and floors to support plug loads, wall lighting, HVAC, etc. For example, during a build-out, the electrical contractor can install electrical outlets and/or junction boxes in a desired spacing in the area above where a removable panel ceiling is or will be installed. The area controllers 14 positioned in a desired location in the removable panel ceiling grid, which is typically proximate to an area and lighting that is to be controlled by the area controller 14. The area controller 14 is plugged into one the electrical outlets above the ceiling or wired to a junction box. Wiring suitable for low voltage, limited energy applications and communication is connected between the area controller 14 and the lights and other devices to be controlled and/or powered, as well as the wired switches, sensors, etc. powered by and communicating with the controller 14. As discussed herein, wired or wireless interfaces can be provided to the area controller 14 in a stand-alone or larger system configuration. However, wireless communication between the area controllers 14 and northbound controllers 12, as well as between various switches and sensors not being powered by the area controller 14 provides enhance flexibility when reconfiguring a space. In those wireless communication deployments, the reconfiguration of the space accomplished is dramatically simplified and more flexible.

The reconfiguration enabled by the present invention is not limited to merely moving lights and other devices with a defined area or even within a given building. The building operator can decide to move an area controller 14, lights, and wireless switches to a different part of a building or a different building all together. The area controller 14 is unplugged from the outlet, lights are disconnected from the area controller 14, switches and sensors are disconnected, etc. In the new location, the area controller 14 replaces a ceiling panel that can be redeployed in the old location. The lights are positioned as desired in the ceiling grid, switches and sensors positioned accordingly. The area controller 14 is plugged into an electrical outlet above the removable panel ceiling and the devices associated with the area controller 14 are powered up. The building operator access the system software running on the automation controller 12 (higher level) and/or the area controller 14 and changes the location and operational settings, as desired. A similar process is followed for area controllers 14 that are wired into junction boxes.

In various embodiments, the system 10 can be configured as a scalable, room-based LED lighting control system that replaces line voltage installation with a distributed system of low voltage area controllers and Class 2 wiring. Each controller 14 could be configured to support up to multiple zones of LED lighting including one or more LED fixtures. The area controller 14 can be configured to include dimming control and control signals can be sent of the low voltage wiring along with the low voltage power to drive a driver and power the LED fixtures. The system 10 can also include wired or self-powered or battery operated wireless switches and sensors. The system can operate as a stand-alone control system, as an integrated part of a building management and automation system (BMS/BAS), or within a wired or wireless building control/management system.

While the area controller 14 has generally been described in terms of ceiling panel, it will be appreciated that it can be deployed above the removable panel ceiling, recessed or within in a wall or flooring, as a floor panel, beneath a floor, or surface mounted. As mentioned herein, the troffer configuration in the removable panel ceiling grid provides some advantages including accessibility to the conditioned side of the housing from with the room and access to the unconditioned side of the housing by moving an adjacent ceiling panel. In addition, the electronics of the area controller 14 can be positioned on the conditioned side of the housing to expose it to room conditions rather than less controlled conditioned above the removable panel ceiling or within walls or flooring.

Also, the area controller 14 has been described predominantly with respect to lighting, one of ordinary skill will appreciate that the area controller 14 can provide control for various of systems and devices. For example, the area controller 14 can be configured to control plug load devices, HVAC equipment, computers, etc., as well as interface with other building systems as desired. In various embodiments, the area controller 14 is configured to turn off a plug load controller or relay circuit in response to an unoccupied area determination by the controller and/or based on schedules or other input.

Similarly, the reconfigurable system described herein can be applied to the walls, flooring, etc. in the structure, as well as cubicles deployed in the structure. For example, electrical plug outlets in walls and cubes in a room can have wires run vertically to the space above the removable panel ceiling or below the flooring, where it could be connected into the line voltage infrastructure via an electrical plug outlet or a junction housing. Similarly, thermostat and/or other temperature detection and control devices can be configured to communicate wirelessly to the HVAC equipment and/or the management system to eliminate the need for re-wire the system when a space is reconfigured.

These and other variations and modifications of the present invention are possible and contemplated, and it is intended that the foregoing specification and the following claims cover such modifications and variations.

What is claimed is:

1. A building lighting system comprising:
an automation controller configured to communicate wirelessly;
a plurality of area controllers configured as removable panel ceiling panels to seat in a removable panel ceiling grid in an area, to communicate wirelessly with the automation controller, and provide control signals to at least one group of lighting fixtures including at least one lighting fixture in the area to control the light output by the lighting fixtures.

2. The building lighting systems of claim 1, wherein the area controllers comprise:
a troffer configured to seat as a ceiling panel in a removable panel ceiling that divides a space into a conditioned first area and a lesser conditioned second area;
a processor mounted in the troffer on the first area side of the removable panel ceiling and configured to issue commands to the lighting fixtures communicating with the processor;
a line voltage power input in the second area to provide electrical power to the panel; and,
a wireless transceiver in communication with the processor and configured to communicate wirelessly with the automation controller.

3. The building lighting systems of claim 2, wherein the area controllers are configured to provide control signals to the lighting fixtures via control wire.

4. The building lighting systems of claim 2, wherein the area controllers are configured to provide control signals to the lighting fixtures wirelessly.

5. The building lighting systems of claim 2, wherein the wireless transceiver is positioned in the second area.

6. The building lighting systems of claim 2, wherein the area controller wirelessly communicate with peripheral devices in the area.

7. The building lighting systems of claim 2, wherein the area controller can be controlled directly through a user interface.

8. The building lighting systems of claim 2, wherein the area controller is configured to communicate with at least one of wired and wireless switches and control the at least one group of lighting fixtures based on the communication with the switches.

9. The building lighting systems of claim 8, wherein the area controller and wireless switches communicate using a different protocol than communications between the area controllers and the automation controller.

10. The system of claim 2, wherein the area controller is configured to control the light intensity output by one of the lighting fixtures separately from the light intensity output by at least one other lighting fixture controlled by the area controller.

11. The controller of claim 2, wherein the wireless transceiver is configured to operate as part of a wireless network and communicate with at least one peripheral device.

12. The controller of claim 12, wherein the plurality of peripheral devices includes at least one of thermostats, plug load controllers, fans, meters, and sensors.

13. The system of claim 1, wherein the area controller further comprises:
a troffer configured to seat as a ceiling panel in a removable panel ceiling that divides a space into a conditioned first area and a lesser conditioned second area;
a processor mounted in the troffer on the first area side of the removable panel ceiling and configured to control the plurality of light fixtures; and,
a line voltage power source input configured to receive power from a power source in the second area.

14. The system of claim 1, further comprising:
at least one photodiode configured to monitor the light intensity in the area and the area controller is configured to vary the light intensity output by at least one lighting fixture based on the monitored light intensity.

15. The system of claim 14, wherein the area controller varies the light intensity to achieve a desired light intensity in the area.

16. A method of operating a building lighting control system comprising:
installing a plurality of light fixtures as panels in a replaceable panel ceiling within an area;
installing an area controller within the area as a panel in the replaceable panel ceiling; and,
controlling the light output intensity of the lighting fixtures with the area controller.

17. The method of claim 16, further comprising providing a light switch configured to wirelessly communicate with the area controller to vary the light intensity output by the at least one low voltage lighting fixture.

18. The method of claim 16 further comprising monitoring the light intensity in the area and varying the light intensity output by at least one lighting fixture to achieve a desired light intensity in the area.

19. The method of claim 16 further comprising providing the area controller with a first wireless transceiver configured to communicate with an automation controller and a second wireless transceiver configured to communicate with at least one wireless switch.

20. The method of claim 16 further comprising:
providing the area controller with a wireless transceiver configured to communicate with an automation controller; and,
controlling the light output by the lighting fixture via control signals transmitted over control wire.
